(19) United States
(12) Patent Application Publication
(10) Pub. No.: US 2008/0252074 A1
(43) Pub. Date: Oct. 16, 2008

(54) Method of Joining Components, Fitting and Tube Joint Where at Least One of the Components Comprises or is Made of Material Difficult to Weld

(76) Inventors: Claes Ohngren, Uppsala (SE); Roger Berglund, Vasteras (SE); Johan Josefsson, Gavle (SE); Mats Lundberg, Sandviken (SE)

Correspondence Address: Carter, DeLuca, Farrell & Schmidt, 445 Broad Hollow Road, Suite 225, Melville, NY, 11747, US

(21) Appl. No.: 11/793,741

(22) PCT Filed: Dec. 21, 2005
(86) PCT No.: PCT/SE2005/001989

§ 371 Date: Nov. 19, 2007

(30) Foreign Application Priority Data
Dec. 21, 2004 (SE) 0403120-9

(51) Int. Cl. F16L 15/00

(52) U.S. Cl. 285/333; 501/71

(57) ABSTRACT

Method of joining at least two components (2, 3) utilising a fitting (1), where at least one of the components comprises, or is made of, a material which is difficult to weld. The components (2, 3) are provided with thicker walls at the end surfaces (6) that are to be joined. At least one of the thicker end walls is provided with an internal or external thread (T) and said at least two components are joined together by screwing said threaded end walls into and/or onto the fitting (1).

### TECHNICAL FIELD

The present invention concerns a method of joining at least two components, such as tubes, utilising a fitting where at least one of the components comprises, or is made of, a material which is difficult to weld.

### BACKGROUND AND PRIOR ART

Interrupting the operation of a large chemical facility involves a significant drop in productivity and loss of revenues for every hour the facility is out of service. Several routine maintenance operations require shutting down major portions of a facility until all work is completed. One such operation is the replacement of cracking furnace tubes used in the production of ethylene.

The tubes used for furnace applications, such as steam crackers, have typical service temperatures in the range of 900-1200° C., they can be up to about 20 m long and consequently quite heavy, and they usually transport corrosive or carbon-containing media. To withstand these high service temperatures, high loads and corrosive or carbonising environments, a number of stainless steel alloys, such as dispersion-hardened alloys, are used. These alloys are specifically formulated to have the desired properties, such as good creep strength, but they pose significant welding problems.

Since these alloys are difficult to weld, the joining of components, such as tubes, made from such alloys can be a very expensive and time-consuming process. The welding process can give rise to the precipitation of carbide-, nitride- and/or oxide clusters, which leads to a significant weakening of the joint. Even if these alloys are welded together, a sufficient joint strength is usually not achieved when the alloys are used at high temperatures. Furthermore welding can damage the geometry of the pipe and consequently adversely affect the flow of medium through the pipes when they are in use.

EP 1018563 discloses a heating furnace tube which has been developed with a view to eliminating inconveniences occurring when a carbon-containing fluid is made to flow in the heating furnace tube. The heating furnace tube comprises a rare earth oxide particle distributed iron alloy containing 17-26 wt. % of Cr and 2-6 wt. % of Al.

The method of manufacturing this heating furnace tube comprises the steps of forming or inserting an insert metal on or into at least one of a joint end portion of one heating furnace tube element and that of the other heating furnace tube element, bringing these two joint end portions into pressure contact with each other and diffusion welding the two heating furnace tube elements to each other by heating the insert metal. A disadvantage with such a method is that it does not provide a joint structure that is sufficiently mechanically stable at high temperatures and high loads.

EP 1418376 describes pipes made of a difficult-to-weld material to be used at a high temperature which are internally and externally threaded at their end portions and which are then thread-fastened to each other. The inner and/or outer faces of the jointed pipe portion are sealed by seal means to retain the gas tightness of the jointed pipe portion. A disadvantage with such pipes is that the mechanical stability of the jointed pipe portion is reduced since material has to be removed from the pipes when threads are cut into the pipes. A mechanically weaker structure implies a shorter life-time of the jointed pipe portion thus increasing labour and material costs.

### SUMMARY OF THE INVENTION

The object of the invention is to provide a simple method of joining at least two components, such as tubes or finned tubes, wherein at least one of the components comprises a material that is difficult to weld, while accomplishing a joint with good mechanical stability.

The object is fulfilled by a joining method utilising a fitting, i.e. an intermediate member. The method comprises the step of providing the components with thicker walls at the end surfaces that are to be joined, by forging or turning for example, providing at least one of the thicker end walls with an internal or external thread i.e. at least part of a complete turn of a projecting helical rib, a complete turn or a plurality of such turns, and joining said at least two components together by screwing said threaded end walls into and/or onto the fitting.

By making the end walls of the components, such as tubes, thicker and by that increasing the cross-section area of the components a reduction of the load per area unit is obtained for this cross-section, which makes it possible to join the components by welding if desired, since even a weld between components of a material that is difficult to weld may resist such a lower load per area unit. The thicker end walls also means that it is possible to provide these with an internal or external thread without reducing the thickness of the component in this region to be smaller than in the rest of the component, which in the case of a tube as said components means that the wall thickness of the tube will not be smaller in the region of the joint. Only the end parts of the components are made thicker since the components have to be able to carry their own weight and withstand bending moments. Increasing the thickness of the whole component also gives rise to higher material costs and adversely affects the components' heat transport properties.

According to an embodiment of the invention said components are provided with thicker walls in a part thereof closest to the respective said end surface so that the thickness of the wall of the component/components provided with a thread is increased in said part by at least 1.4, preferably 2-3.5, times the depth of said thread with respect to the rest of said component. Such a thickness increase results in favourable reduction of load per area unit for the cross-section defined by the end surfaces to be joined, although the end walls are provided with threads, so that a joint having sufficient mechanical strength for taking the load even if welded is so obtained. The FIG. 1.4 does here mean that the thickness in increased by the depth of the thread plus 40% of that depth.

According to an embodiment of the invention said components are tubes and they are provided with thicker walls in a part closest to the respective said end surface so that the thickness of the wall of each tube is in said part increased by 33-100%, preferably 50-80%, with respect to the wall thickness of the rest of the tube, which results in an advantageous reduction of load per area unit for the cross-section of the joint even if said end parts are provided with a thread.

According to an embodiment of the invention said components are provided with thicker walls in a part thereof closest to said end surfaces by forging this part of each component. It has turned out that forging is the most cost-effective method for obtaining such enlarged cross-section of the end surfaces of components to be joined, especially tubes.

According to an embodiment of the invention the method comprises the step of providing at least one fluid-tight seal, i.e. a liquid-tight or a gas-tight seal, by welding the end surfaces of the fitting to said at least two components. The flow or composition of any medium flowing through the components will not therefore be altered as it passes through the joint structure. The fluid-tightness will furthermore be retained at high temperatures.

According to another embodiment of the invention the method comprises the step of providing a weld between said at least two components at their contact surfaces, which may conveniently be done thanks to the thicker walls of the end parts.

According to a further embodiment of the invention said fitting is an internal fitting that is placed inside end parts closest to said end surfaces of said at least two components that are to be joined or an outer sleeve placed around the end parts of said at least two components that are to be joined.

According to a yet further embodiment of the invention the method comprises the step of providing the fitting with means, such as one or more shoulders, adapted to form a support for at least one of said components substantially in the joining direction. The joining direction is here the direction in which the fitting is displaced with respect to a said component when screwed thereinto or thereonto. According to an embodiment of the invention said at least one component that is supported by said support means of the fitting is not provided with a thread.

According to an embodiment of the invention the method comprises the step of welding said at least two components in addition to screwing them into/onto the fitting.

The expression “material that is difficult to weld” includes materials that lose their mechanical properties or corrosion resistance when welded. One example of a material that loses its mechanical properties when welded is a dispersion strengthened ferrous alloy. According to another embodiment of the invention said material that is difficult to weld comprises a dispersion-hardened alloy containing in weight-%: C up to 0.08, Si up to 0.7, Cr 10-25, Al 1-10, Mo 1.5-5, Mn up to 0.4, balance Fe and normally occurring impurities.

According to an alternative embodiment of the invention said material that is difficult to weld comprises Kanthal APM, an iron-chromium-aluminium (FeCrAl) alloy developed through Kanthal's Advanced Powder Metallurgy (APM) technology, or APMT i.e. the same FeCrAl alloy base as Kanthal APM but with added molybdenum.

According to an embodiment of the invention such a material that is difficult to weld may be welded to a component that is easier or easy to weld, such as austenitic stainless steel.

According to another embodiment of the invention the method comprises the step of cutting the thread to be parallel or tapered, whereby a tapered thread increases the load-bearing surface.

According to a further embodiment of the invention the material in which the thread is cut is the same as the material of one or more of said at least two components.

The present invention also concerns a fitting for joining at least two components, such as tubes, where at least one of the components comprises a material that is difficult to weld. The fitting is provided with an internal and/or external thread over at least part of its inner and/or outer surface.

According to an embodiment of the invention the thread is parallel or tapered. According to another embodiment of the invention the fitting comprises means, such as one or more shoulders, adapted to form a support for at least one said component substantially in the joining direction. According to a further embodiment of the invention the fitting comprises a metallic or ceramic material.

According to an embodiment of the invention the fitting comprises a dispersion-hardened alloy containing in weight-%: C up to 0.08, Si up to 0.7, Cr 10-25, Al 1-10, Mo 1.5-5, Mn up to 0.4, balance Fe and normally occurring impurities.

The present invention even relates to a tube joint comprising at least two tubes, where at least one of the tubes comprises a material that is difficult to weld and a tube fitting. The tube fitting is a fitting according to any of the embodiments described above. The tubes have thicker walls at the end surfaces which are to be joined. At least one thicker end part of at least one tube is partly or fully threaded.

According to an embodiment of the invention the tube joint is provided with at least one fluid-tight seal by welding the end parts of the tube fitting to said at least two tubes. According to another embodiment of the invention the tube joint comprises a weld between said at least two tubes at their contact surfaces.

According to another embodiment of the invention the tube joint comprises two tubes each having an external thread in said thicker walls thereof closest to said end surfaces, the fitting has two internal threads adapted to engage said external thread of a tube each and a portion with a reduced inner diameter substantially equal to the inner diameter of the tube separating said internal threads and adapted to separate said end surfaces of said tubes when joined while forming an inner wall of the tube joint substantially flush with adjacent inner walls of the tubes. An advantage of this embodiment is that it is not necessary to weld. This tube joint will also have a smooth inner surface, which may be compared with a weld provided between the tubes resulting in a small “boss” inside the tube joint, which could slightly disturb the flow of the gas inside the tubes at the two joints.

Use of a method, a fitting or a tube joint according to any of the embodiments described above in corrosive conditions or high temperature or high load applications, such as at temperatures over 900° C. or in cracking furnaces is also a part of the invention.

Further advantages as well as advantageous features of the invention appear from the following description and the other dependent claims.

### BRIEF DESCRIPTION OF THE DRAWINGS

FIGS. 1-5 illustrate joint structures between two tubes of the same diameter according to embodiment of the invention,

FIG. 6 illustrates examples of the geometrical form of the threads of the inventive fitting, and

FIG. 7 illustrates part of a joint structure wherein the tube fitting has a tapered inner surface.

It should be noted that the figures are not drawn to scale and that the size of certain features has been exaggerated for the sake of clarity.

The following description and drawings are not intended to limit the present invention to the embodiment disclosed. The embodiment disclosed merely exemplifies the principles of the pre-sent invention.

### DETAILED DESCRIPTION OF THE INVENTION

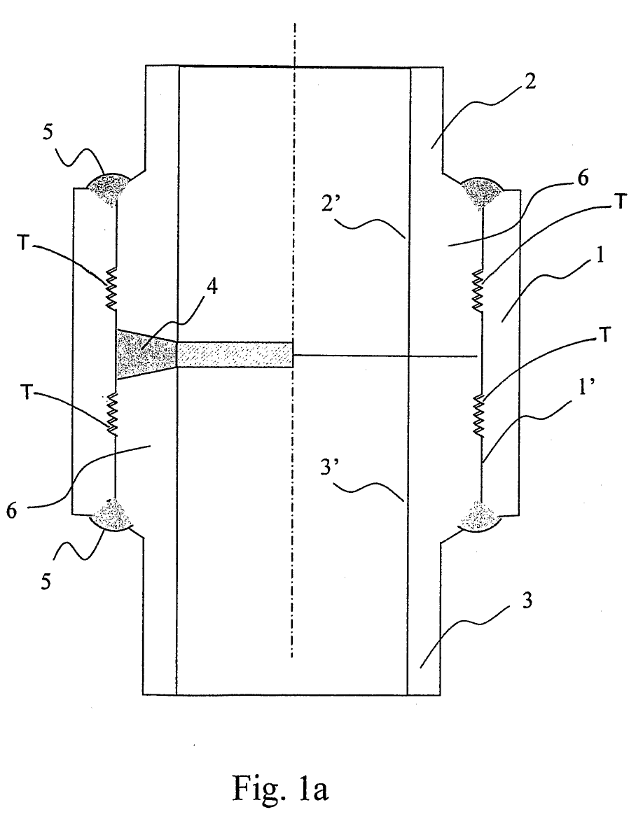

FIG. 1a shows two partly threaded tubes 2,3, that are joined by means of a partly threaded exterior tube fitting 1 made of a metallic or ceramic material. The tubes 2,3, may be heating pipes or high-temperature process pipes used in oil refineries, chemical- or petrochemical plants, power generation plants, steelmaking plants or nuclear power installations for example.

Although the tubes 2,3, in this example are of the same diameter the inventive joining method may be used to join tubes of different diameters. Furthermore tube fittings having a plurality of branches, such as Y-shaped, may be used to join a plurality of tubes.

The tube fitting 1 is not threaded over its entire inner surface 1′. It is threaded only on parts (T) of its inner surface 1′. Both of the tubes 2,3 are provided with corresponding threads on their outer surfaces, thereby providing the possibility of screwing the tubes 2,3 and the tube fitting 1 together to from a joint structure whereby the threads support the weight of the tubes 2,3.

At least one or both of the two tubes 2,3 is made of a material that is difficult to weld, such as an iron-based dispersion-strengthened material. The fitting 1 may also be made from such a material or a different material. The two tubes 2,3 may also be joined along the end surfaces by means such as a weld 4. This weld 4 can be any means of providing a fluid-tight connection between the tubes 2,3. Said fluid-tightening means should be chosen so as not to substantially alter the high temperature properties of the tube material.

The weld 4 may be load bearing. Due to the presence of the weld 4, the medium flowing through the tubes 2,3 during operation will not be able to penetrate into the threads, T, of the tubes 2,3 and the tube fitting 1. The risk of corrosion or degradation of the threads T by the medium flowing through the tubes 2,3 will therefore be eliminated. A sealing weld 5 is provided at the end surfaces of the tube fitting 1, between the tube fitting 1 and the tubes 2,3 to provide a fluid-tight seal.

The tubes 2,3 have thicker walls 6 at the end surfaces at which they are to be joined. The mechanical stability of the joint structure is thereby improved and the tubes may be provided with threads without removing too much material from the tubes themselves. Thin tube walls would increase the load per area unit of the joint and make it impossible to join the tubes by a weld.

The joint structure provides a precise fit without irregularities along the inner surfaces of the two tubes 2′, 3′, whose presence could otherwise adversely affect the flow of any medium flowing through the tubes.

The embodiment shown in FIG. 1b differs from that shown in FIG. 1a in that thread is provided along the entire inner surface of the fitting 1 but only along parts of the outer surface of the tube end parts. Alternatively thread may be provided along the entire outer surface the tube end parts but only along parts of the inner surface of the fitting 1. The regions indicated by the reference sings T_{f} indicate the areas were the tubes' and the fitting's threads overlap. In the areas where threads do not overlap, i.e. when the thread of the fitting or of a tube end part abuts on an unthreaded area of the fitting or of a tube end part an air gap is formed therebetween. The presence of such an air gap decreases the thermal conductivity of the joint structure.

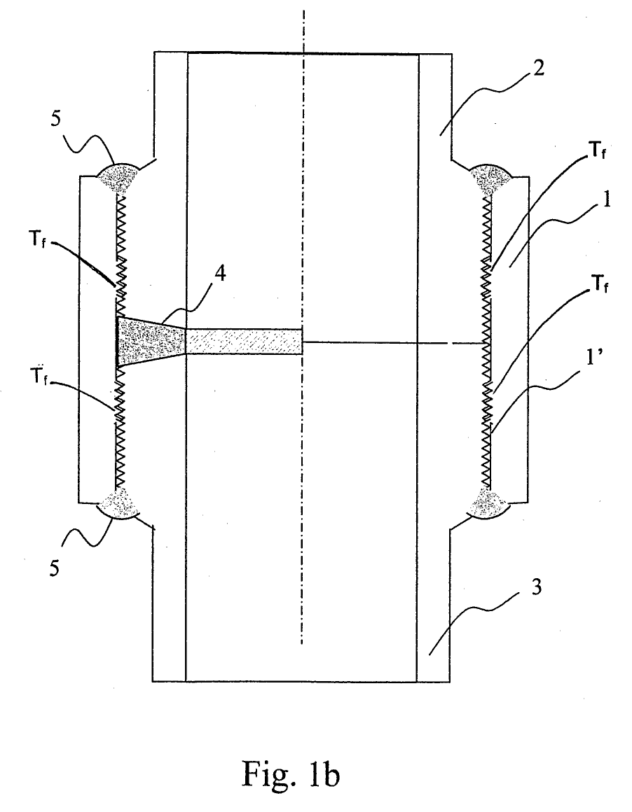

The embodiment shown in FIG. 2 differs from the embodiments shown in FIGS. 1a and 1b in that thread T is provided along the entire outer surface of the tube end parts and along the entire inner surface of the fitting 1.

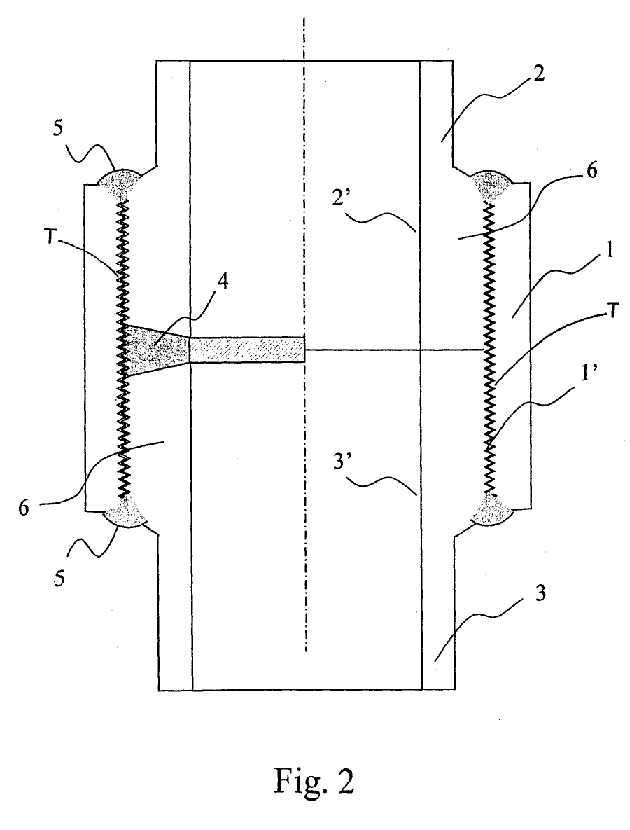

FIG. 3 shows a further embodiment of the invention where the tube fitting 1 comprises a load-bearing shoulder 8 at its lower end 7. The inner diameter of the tube fitting 1 is therefore smaller at its lower end 7 than the inner diameter along the rest of the tube fitting 1. The load-bearing shoulder 8 support tube 3, since the thicker end part of the tube 3 rests on the shoulder 8.

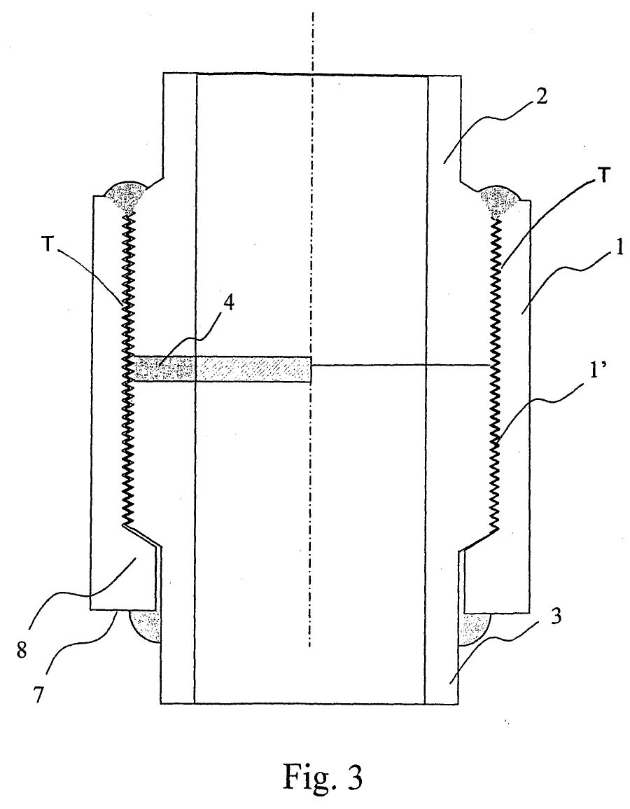

The embodiment shown in FIG. 4 differs from that shown in FIG. 3 in that only the upper tube, tube 2, is provided with a thread, T₂. The lower tube, tube 3 is not threaded and is merely inserted into the tube fitting 1 which is then welded to the outer surfaces of the tubes 2,3. The load-bearing shoulder 8 does here together with the threads T₂ keep the tube 3 joined to the tube 2. This allows tube 3 to move more freely inside the joint since the thermal expansion of tube 3 does not exert a force on the threads of the tube fitting, thereby prolonging the service life of the tube fitting.

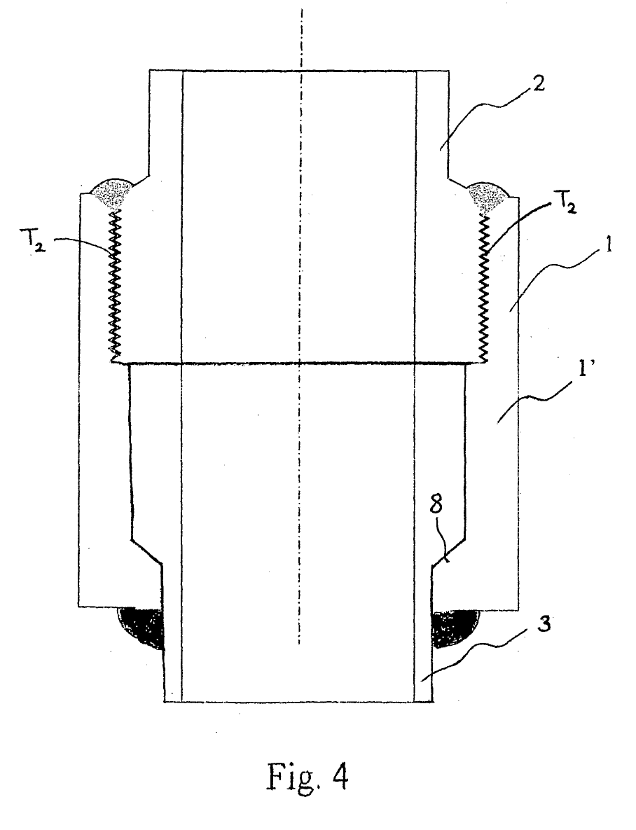

FIG. 5 shows a tube fitting 1 with a shoulder 9 whereby threads T are located on the vertical surfaces that are in contact with the outer surfaces of the tube end parts. This embodiment is advantageous, since it results in a smooth inner surface of the tubes in the joint region. Furthermore, it is advantageous compared to the embodiments according to FIGS. 2 and 3 by the fact that it is easier to obtain a proper transition between the fitting and the two tubes in this embodiment, i.e. to obtain that the threads for all three parts coincide. A reason for this is that each tube 2, 3 has a point of its own for the transition to the fitting.

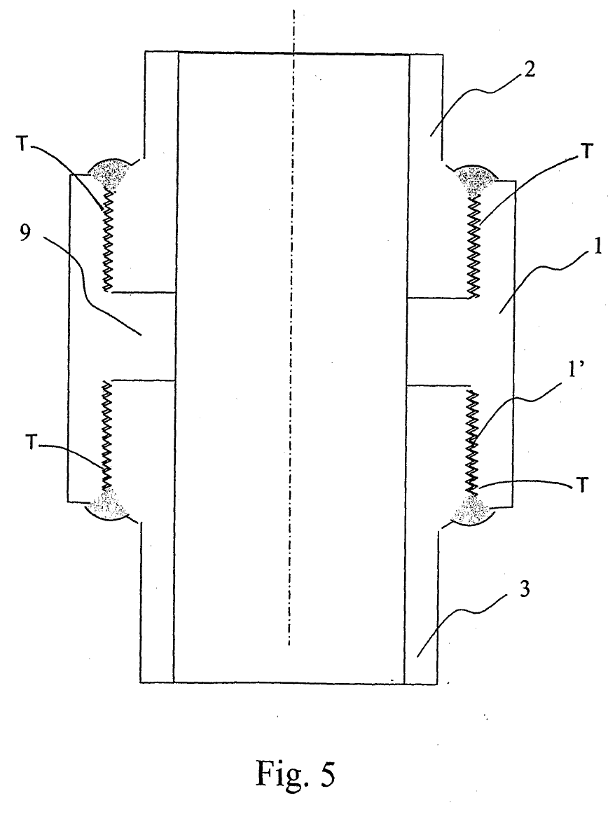

The threads may have any geometrical form. They may for example have a saw-tooth or square-tooth profile as shown in FIGS. 6a and 6b respectively. In the latter case the horizontal surfaces of the square-tooth profile may act as additional load-bearing surfaces and thereby further improve the mechanical stability of the joint structure as compared with a saw-tooth profile.

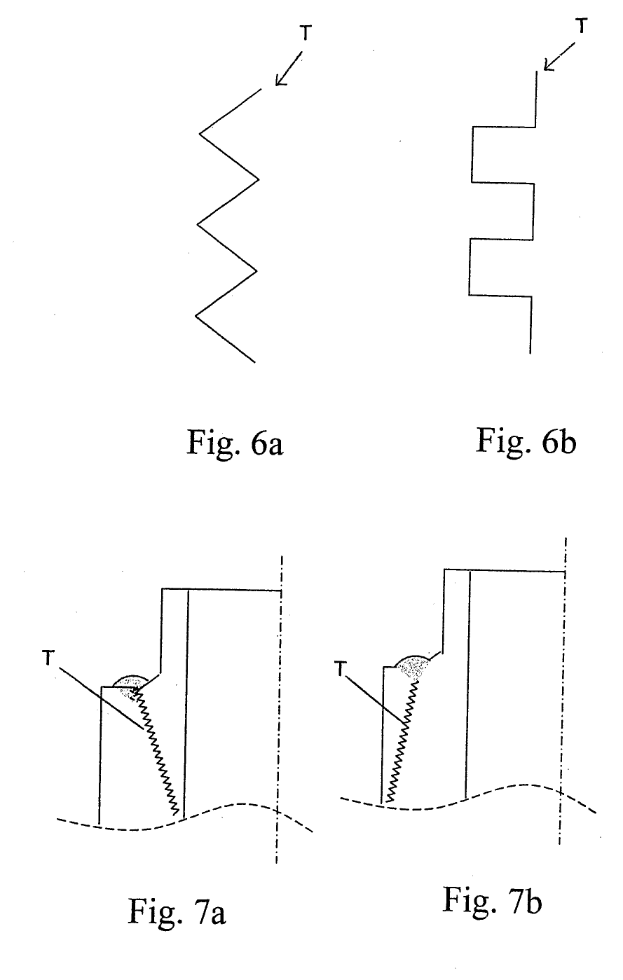

Furthermore the threaded surface may be tapered in order to facilitate the joining and thereby provide a greater load-bearing surface and consequently improve the mechanical stability of the joint, see FIGS. 7a and 7b. Either the entire inner surface of the tube fitting or only part of said surface may be tapered.

The invention is of course not in any way restricted to the embodiments thereof described above, but many possibilities to modifications thereof would be apparent to a man with ordinary skill in the art without departing from the basic idea of the invention as defined in the appended claims. For example although an exterior fitting located around two components has been exemplified in the figures, the invention is equally suitable for joining two or more components using an internal fitting located inside two components.

1. A method of joining at least two components (2, 3), such as tubes, utilizing a fitting (1), where at least one of the components comprises, or is made of, a material which is difficult to weld, characterized in that it comprises the step of providing the components (2, 3) with thicker walls at the end surfaces (6) that are to be joined, providing at least one of the thicker end walls with an internal or external thread (T) and joining said at least two components together by screwing said threaded end walls into and/or onto the fitting (1).

2. A method according to claim 1, wherein said components (2, 3) are provided with thicker walls in a part thereof closest to the respective said end surface so that the thickness of the wall of the component/components provided with a thread is increased in said part by at least 1.4, preferably 2-3.5, times the depth of said thread (T) with respect to the rest of said component.

3. A method according to claim 1 wherein said components (2, 3) are tubes and that they are provided with thicker walls in a part closest to the respective said end surface so that the thickness of the wall of each tube is in said part increased by 33-100%, preferably 50-80%, with respect to the wall thickness of the rest of the tube.

4. A method according to claim 1, wherein said components (2, 3) are provided with thicker walls in a part thereof closest to said end surfaces by forging this part of each component.

5. A method according to claim 1 comprising the step of providing at least one fluid-tight seal (5) by welding the end surfaces of the fitting (1) to said at least two components (2, 3).

6. A method according to claim 1 comprising the step of providing a weld (4) between said at least two components (2, 3) at their contact surfaces.

7. A method according to claim 1, wherein said fitting (1) is an internal fitting that is placed inside end parts closest to said end surfaces of said at least two components that are to be joined or an external sleeve placed around said end parts of said at least two components that are to be joined.

8. A method according to claim 1 comprising the step of providing the fitting (1) with means, such as a shoulder (8), adapted to form a support for at least one said component (3) substantially in the joining direction.

9. A method according to claim 8, wherein said at least one component that is supported by said support means (8) of the fitting (1) is not provided with a thread (T).

10. A method according to claim 1 comprising the step of welding said at least two components in addition to screwing them into/onto the fitting (1).

11. A method according to claim 10, wherein said at least two components are welded together.

12. A method according to claim 1, wherein said material that is difficult to weld comprises a dispersion-hardened alloy containing in weight-%:
C up to 0.08
Si up to 0.7
Cr 10-25
Al 1-10
Mo 1.5-5
Mn up to 0.4
balance Fe and normally occurring impurities.

13. A method according to claim 1, wherein said material that is difficult to weld comprises a dispersion-hardened alloy such as an iron-based dispersion-strengthened material.

14. A fitting (1) for joining at least two components, such as tubes, where at least one of the components comprises a material that is difficult to weld, characterized in that it is provided with an internal and/or external thread (T) over at least part of its inner (I′) and/or outer surface.

15. A fitting (1) according to claim 14, comprising means, such as one or more shoulders (8), adapted to form a support for at least one said component substantially in the joining direction.

16. A fitting (1) according to claim 14, comprising a metallic or ceramic material.

17. A fitting (1) according to claim 14 comprising a dispersion-hardened alloy containing in weight-%:
C up to 0.08
Si up to 0.7
Cr 10-25
Al 11-10
Mo 1.5-5
Mn up to 0.4
balance Fe and normally occurring impurities.

18. A tube joint comprising at least two tubes, where at least one of the tubes comprises a material that is difficult to weld and a tube fitting (1), wherein the tube fitting (1) is a fitting (1) according to claim 15 and in that the tubes have thicker walls at the end surfaces which are to be joined and in that at least one of the tubes has a thread (T) in a said thicker end wall.

19. A tube joint according to claim 18, wherein said tubes (2, 3) are provided with thicker walls in a part thereof closest to the respective said end surface so that the 'thickness of the wall of the tube/tubes provided with a thread is increased in said part by at least 1.4, preferably 2-3.5, times the depth of said thread (T) with respect to the rest of said tube.

20. A tube joint according to claim 18, wherein the tubes are provided with thicker walls in a part closest to the respective said end surface so that the thickness of the wall of each tube is in said part increased by 33-100%, preferably 50-80%, with respect to the wall thickness of the rest of the tube.

21. A tube joint according to claim 18, wherein said tubes (2, 3) are provided with thicker walls in a part thereof closest to said end surfaces, and that the thicker walls have been produced by forging this part of each tube.

22. A tube joint according to claim 18, wherein the tube joint is provided with at least one fluid-tight seal (5) by welding the end surfaces of the tube fitting (1) to said at least two tubes (2, 3).

23. A tube joint according to claim 18 the tube joint having a weld (4) between said at least two tubes at their contact surfaces.

24. Tube joint according to claim 18 comprising two tubes (2, 3) each having an external thread in said thicker walls thereof closest to said end surfaces, that the fitting has two internal threads adapted to engage said external thread of a tube each and a portion (9) with a reduced inner diameter substantially equal to the inner diameter of the tubes separating said internal threads and adapted to separate said end surfaces of said tubes when joined while forming an inner wall of the tube joint substantially flush with adjacent inner walls of the tubes.

25. A use of a method according to claim 1, a fitting according to claim 14 or a tube joint according to claim 18 in corrosive conditions or high temperature applications, such as at temperatures over 900° C.

26. A use of a method according to claim 1, a fitting according to claim 14 or a tube joint according to claim 18 in cracking furnaces.

27. A method of joining at least two components (2, 3), such as tubes, utilizing a fitting (1), where at least one of the components comprises, or is made of, a material which is difficult to weld, which comprises the step of providing the components (2, 3) with thicker walls at the end surfaces (6) that are to be joined, providing at least one of the thicker end walls with an internal or external thread (T) and joining said at least two components together by screwing said threaded end walls into and/or onto the fitting (1), characterized in that when the components (2, 3) are provided with thicker end walls this is done so that also when not considering the part of the thickness of the component occupied by a said thread said component has substantially thicker end walls at said end surfaces that it has in the rest thereof.
